(19) United States
(12) Patent Application Publication
(10) Pub. No.: US 2017/0135794 A1
(43) Pub. Date: May 18, 2017

(54) VORRICHTUNG UND VERFAHREN ZUR KEIMARMEN SAMENGEWINNUNG VON EBERN

(71) Applicant: Stephanie Neidhardt, (US)

(72) Inventor: Detlef Rath, Neustadt (DE)

(21) Appl. No.: 15/115,975

(22) PCT Filed: Feb. 11, 2015
(86) PCT No.: PCT/EP15/52902

§ 371 Date: Dec. 15, 2016

(30) Foreign Application Priority Data
Feb. 12, 2014 (DE) 102014202522.2

(51) Int. Cl. A61D 19/02; A01K 29/00

(52) U.S. Cl. CPC A61D 19/021; A01K 29/00; A61D 19/025; A61D 19/024

(57) ABSTRACT

The present invention relates to a device and method for collecting semen from boars. The device is characterized in that it has a simple structure and is therefore inexpensive to produce and, during the method, it reduces contamination, in particular the microbe count. The device has a glove (1) with a fingers portion (2) and a thumb portion (3) for receiving a hand and, on one side of the glove (1) between the fingers portion (2) and the thumb portion (3), it has a film tube (5) with an opening (6) which is held open by a spring element (10), and of which the opposite, second end (13) is closed, wherein the film tube (5) is connected to the glove (1).

The present invention relates to a device and a method for collecting semen from a boar. The device is characterized in that it has a simple and thus cost-effectively manufactured structure and it reduces impurities within the method, in particular the germ load. Accordingly, the method, which is carried out using the device, is characterized by a simple handling of the device and the collection of the semen with less contamination, in particular less germ load.

US2002/0133090 A1 and U.S. Pat. No. 899,251 A describe elastic shells for collection of ejaculate in animal breeding for vaginal arrangement, which shells are held up by an elastic material.

It is known to let a boar climb over a phantom, in which an artificial vagina is attached. This method has the advantage to reduce the entry of impurities into the semen collected and the disadvantage of additional handling of the artificial vagina.

U.S. Pat. No. 5,961,503 A describes, for semen collection by means of the hand method from the boar, a container, which has an upper and a lower part, between which a filter and a predetermined tearing point are arranged so that the filter with retained material can be separated with the upper part from the lower part.

For the conventional hand method for semen collection, pressure is exerted for a boar with a gloved hand onto the penis tip and the ejaculate is collected with an container, which has a funnel opening. The conventional hand method has the disadvantage of promoting impurities of the ejaculate, e.g. through dust and impurities from the skin of the boar.

The invention has the objective to provide a simple-to-handle and cost-effectively manufactured device for collecting semen from the boar and a method that can be carried out with the same, which method reduces the contamination resp. germ load of the semen.

The invention solves the task with the features of claim 1 and in particular with a device, which has or consists of

a hand covering for accommodating a hand, e.g. a foil bag, preferably with at least one guide for a thumb, in particular shaped as a glove,
a foil hose, which is attached on one side of the hand covering, preferably at an angle of 30° to 90° with respect to the longitudinal axis of the hand covering, the first end of which has an opening, which is spanned open by a spring element in the area of the hand covering and the second end of the foil hose opposite the first end is closed,
wherein the foil hose is preferably arranged between a section of the hand covering for accommodating fingers and an adjacent section for accommodating a thumb,
wherein the foil hose is preferably connected in the area of its opening in a first attachment with the hand covering, optionally additionally in a second attachment that is spaced apart,
wherein the foil hose preferably is connected in the area of the spring element with the hand covering or the spring element is directly connected with the hand covering,
wherein the spring element optionally extends over at least 30%, more preferably at least 50%, more preferably at least 100% of the length of the section of the foil hose, which lies against the hand covering or is attached to it,
wherein the foil hose is preferably attached in at least a second attachment to the hand covering, which is spaced apart by the width of a hand, e.g. 7 to 12 cm, from the opening and, more preferably, the foil hose is attached end-to-end over a length, which corresponds to the width of a hand, e.g. 7 to 12 cm to the hand covering,
optionally a screening device, which spans over the cross-section of the foil hose between the first end and the second end,
optionally a predetermined tearing point, which is arranged between the first end and the second end, preferably between a screening device and the second end and allows a manual tearing-off of the second section of the foil hose, which extends between the predetermined tearing point and the second end,
optionally an electronically and/or optically writable label on the foil hose, which is preferably attached between the hand covering and the second end, more preferably between the predetermined tearing point and the second end, and
optionally a second spring element, which spans over the foil hose at a distance from the opening, e.g. by the width of a hand, e.g. 7 to 12 cm, and more preferably is connected with the hand covering.

The hand covering can consist of plastic foil, e.g. polyethylene, polypropylene and/or polyvinyl or latex. The foil hose can, independently of the material of the hand covering, consist of plastic foil, e.g. polyethylene, polypropylene and/or polyvinyl, less preferably latex. The hand covering and the foil hose can optionally have two foils attached on top of each other along seams, e.g. weld seams, a foil each, which is closed along a seam, or a circumferentially seamlessly closed foil with the exception of the opening in the foil hose and an opening of the hand covering. For the connection by welding, the parts to be welded hand covering, foil hose and/or spring element are made of thermoplastic plastics.

The foil hose can be attached to the hand covering by a wall section of the foil hose being glued and/or welded to a wall section of the hand covering. Optionally, the hand covering can consist of the same material as the foil hose.

Spring elements can be formed as reinforcement of the foil hose, e.g. the spring element can be formed at the first end of the foil hose as folded and fixed, e.g. welded section of the foil hose and/or of the hand covering, optionally with an elastic element arranged therein. Spring elements can be arranged on the inner side or preferably on the external side of the foil hose, e.g. welded or glued, optionally in a section of the foil hose that is pushed onto itself.

Spring elements in the unloaded state can open up a round to oval cross-section and optionally be formed as an open or closed ring and/or spiral, which extends longitudinally with respect to the foil hose. The spring element preferably consists of plastics.

The section of the foil hose, which is arranged at its second end can have a closed grommet, preferably arranged terminally. Such grommet, in particular made of plastics, which is preferably formed in one piece with the terminal second section of the foil hose, within the method can be opened easily through cutting up in order to pour the collected ejaculate out of the foil hose.

The second section arranged at the second end of the foil hose can consist of a material other than the adjacent foil hose and/or have another wall thickness, optionally shaped as a cup or a bottle. This terminal section is tightly connected with the adjacent foil hose, e.g. welded, glued or formed in one piece with it.

The foil hose is preferably double-walled at least in the second section, which forms the second end, and has an inlet for a temperature control medium, which is preferably closable with a valve. As a temperature control medium, water can be used in the method. The double-walled second section for temperature control is preferred, since the fertility of the sperm in the undiluted ejaculate can fall at temperatures below the body temperature. The foil hose can be formed double-walled in its terminal section by the section arranged at the second end being a double-walled container, which is tightly connected with the foil hose. Such container can be formed by a double-walled foil, the inner and/or outer foil of which can be elastic or rigid, e.g. independently from one another with a wall thickness of 0.1 to 1.5 mm, e.g. made of polypropylene or polyethylene.

The hand covering has in total a stretched form, which is suitable for accommodating a hand, e.g. rectangular to oval, preferably with a guide for a thumb, preferably two guides for thumbs arranged side by side at a distance, so that a right or left hand can be arranged in the hand covering and a guide is provided for the thumb, respectively. Preferably, the hand covering has two to four guides for fingers. Guides for thumbs resp. fingers can be produced by connection of sections of the hand covering, e.g. in the form of welding or adhesive seams, which separate the guides from one another. The hand covering can be made of two foils connected along the edges or a foil hose and is open only at an end, through which the hand can be inserted. Preferably, the hand covering has the form of a glove.

The foil hose is attached with the hand covering in the area between its finger section, which serves for accommodating fingers and their thumb section, which serves for accommodating the thumb of a hand, so that the hand covering arranges with its finger section and its thumb section around opposite areas of the foil hose, resp. the foil hose is surrounded by the hand covering during insertion of a hand into the hand covering. Accordingly, the foil hose is arranged at an angle of approx. 45° to 90° with respect to the finger section and/or thumb section.

Preferably, the foil hose has a screening device, which spans over the cross-section of the foil hose between the first end and the second end. The screening device serves for retaining the bulbourethral gland secretion. The screening device can be made of at least one layer of a screening fabric, e.g. gauze. The screening device is preferably connected with the inner wall of the foil hose, e.g. circumferentially welded or glued to the foil hose.

Since the bulbourethral gland secretion is to be separated from the sperm-containing ejaculate, a predetermined tearing point of the foil hose is preferably arranged between the screening device and the second end, e.g. at a distance of 2 to 10 cm from the screening device. The predetermined tearing point can e.g. be a circumferential weakening of the foil hose, e.g. a perforation, which crosses the wall thickness of the foil hose incompletely.

The foil hose preferably on its second section, which is arranged at its second end, has a label that is writable in an electronically and/or optically visible manner, e.g. an electronically writable transponder and/or a label for an or with an optically readable code and/or a readable labelling.

The foil hose at its first end has a spring element, which spans open its opening and preferably a second spring element, which is spaced apart from the opening and which keeps open the foil hose in order to keep open the cross-section of the foil hose at least over the hand covering for the passage of the ejaculate. The first and second spring elements can be formed in one piece. Preferably, the spring element extends to at least 30%, preferably to at least 50%, more preferably to 90 to 100% over the length of the foil hose from the first attachment over the hand covering. With a second attachment, the spring element preferably extends between the first and the second attachment on the hand covering.

The first and second attachment of the foil hose on the hand covering can e.g. be arranged at a spacing, which corresponds to the width of a hand, e.g. 7 to 12 cm, the foil hose is preferably connected with the hand covering throughout from the first up to the second attachment.

The invention will now be described more precisely by means of examples and with reference to the figures, which show schematically in

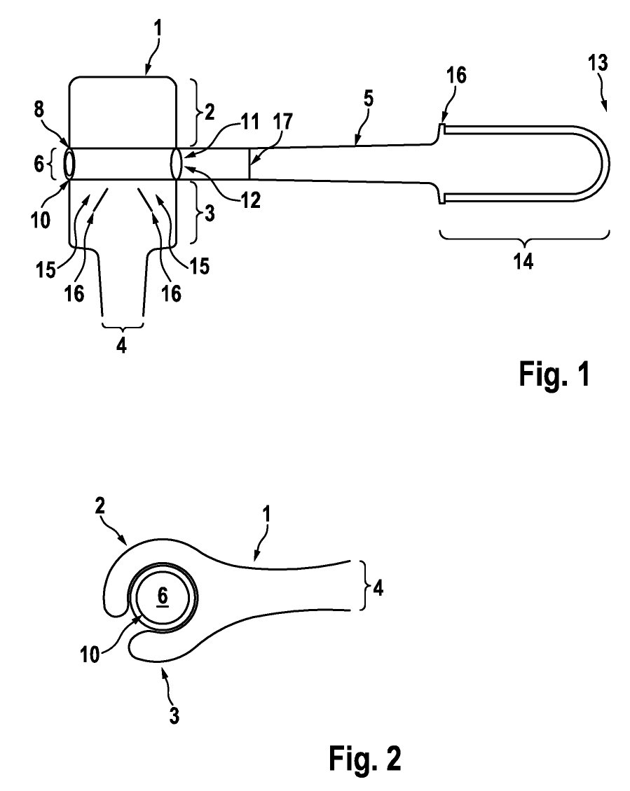

FIG. 1 a top view of a simple embodiment of the device,

FIG. 2 a simple embodiment of the device rotated by 90° with respect to FIG. 1,

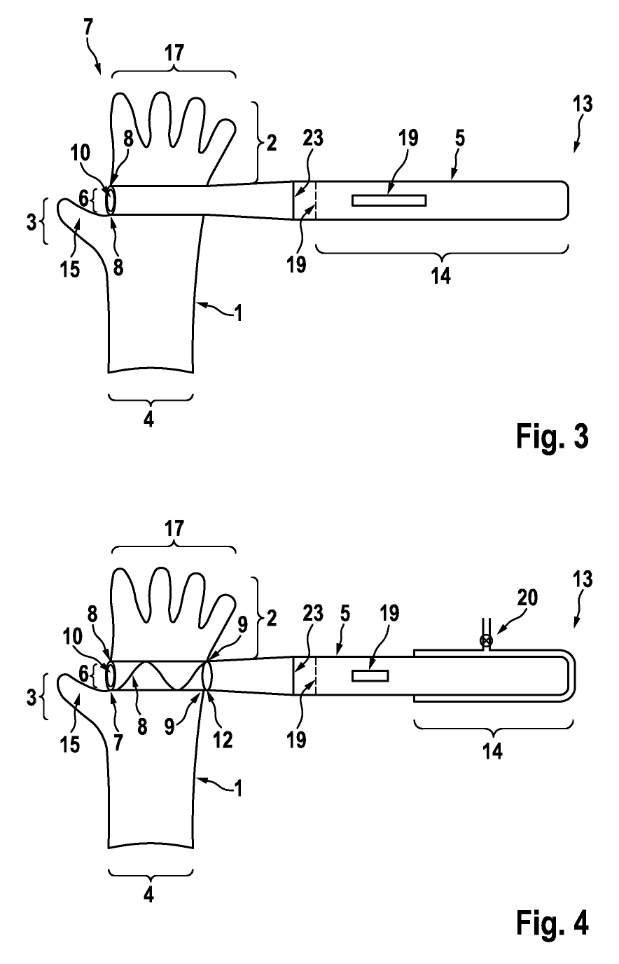

FIG. 3 a preferred embodiment of the device,

FIG. 4 another preferred embodiment of the device,

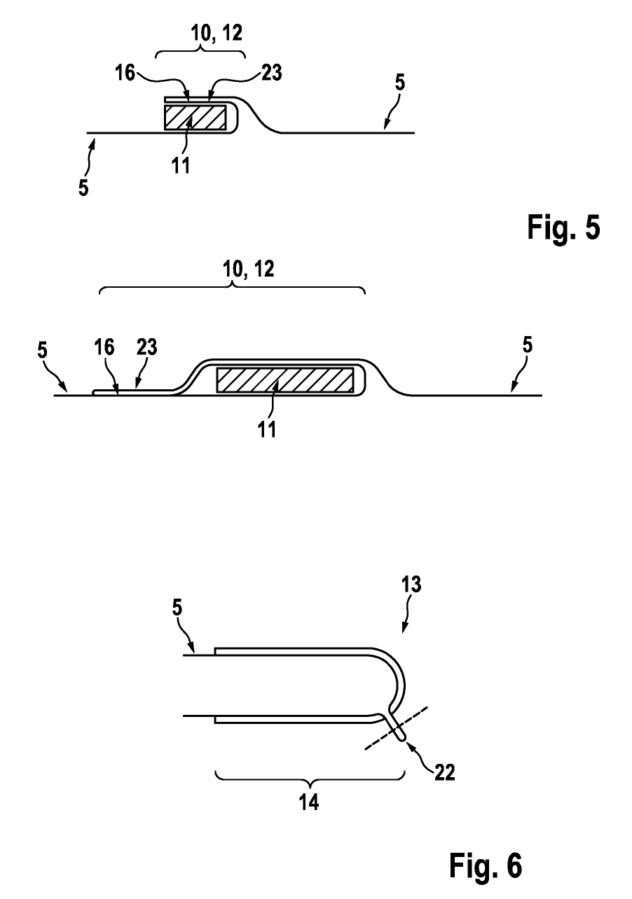

FIG. 5 a spring element arranged on the foil hose and

FIG. 6 in sections the closed second end of the device.

In the figures, the same reference numerals designate elements having the same function. Individual elements shown in the figures can be combined with other embodiments.

FIG. 1 shows a hand covering 1 made of plastic foil, which is approximately rectangular in the flat state, with an approximately rectangular finger section 2 and an adjacent thumb section 3, which is likewise rectangular. The hand covering 1 is closed circumferentially, with the exception of a hand opening 4, through which a hand can be inserted. This embodiment shows a simple hand covering without guides for fingers. An thumb guide 15 can e.g. be formed by means of a weld seam 16.

In the area between finger section 2 and thumb section 3 a foil hose 5 is connected with the hand covering 1, in particular on the opening 6 at the first end 7 of the foil hose 5 by means of a first attachment 8, as well as according to the preferred embodiment on a second attachment 9, which is arranged at a spacing corresponding to an hand width from the first attachment 8. The opening 6 has a circular spring element 10, which spans open the opening 6 and consists of the end of foil hose 5, which is folded and welded circumferentially at least in sections for attachment. The spring element 10 also forms a reinforcement of the edge of the opening 6. In addition to the first attachment 8 the foil hose 5 is connected to the hand covering 1 by means of a second attachment 9, wherein the foil hose 5 in the area of the second attachment 9 has a second spring element 12, which spans open the cross-section of the foil hose 5 at its opening 6. The second spring element 12 can be a section that is pushed together and connected at least in sections, in particular a welded section of the foil hose 5. Alternatively, the first spring element 10 and/or the second spring element 12 can have an elastic element 11 or consist thereof, which is e.g. an open or closed ring, which is attached inside in the foil hose 5, preferably outside on the foil hose 5.

The foil hose 5 is closed at its second end 13 opposite the first end 7 and is double-walled in the second section 14 at the second end 13. It is shown that the terminal second section 14 is formed as a double-walled container, which is tightly connected with the foil hose 5, e.g. glued or welded.

A screening device 23, which is formed by at least one layer of a porous fabric resp. a screening fabric, is arranged in a section of the foil hose 5 between the hand covering and the second section 14. The screening device 23 is e.g. welded circumferentially with the foil hose 5.

FIG. 2 shows a top view of the device in the state, in which a hand is arranged in the hand covering 1. The finger section 2 and the thumb section 4 are arranged around the foil hose 5 so that the foil hose 5 is held by its attachment to the hand covering 1. The spring element 10, which spans open the opening 6 of the foil hose 5 is generally preferably attached adjacent to a finger guide to the hand covering 1.

FIG. 3 shows a device with a preferred embodiment of the hand covering 1, which in its finger section 2 has the finger guides 17 and in its thumb section 3 a thumb guide 15. Here, it is clear that the foil hose 5 is preferably arranged at an angle of 45° to approx. 90° with respect to the finger guides 17. The opening 6 of the foil hose 5 is, as is generally preferred, attached on the edge of the hand covering 1 so that in the flat state of the hand covering, i.e. without any hand inserted into the hand covering 5, the thumb guide 15 projects over the first end 7 of the foil hose 5. The opening 6 of the foil hose 5 has a spring element 10, which spans open the opening 6. By means of a first attachment 8 in the area of the spring element 10 the foil hose 5 is connected to the hand covering 1 on an edge, which is an outer edge of a finger guide 17, which is protruded by the thumb guide 15.

The foil hose 5 is formed along the second section 14 from a layer of a foil and closed at the second end. Between the screening device 23 and the second section 14, there is a predetermined tearing point 18, e.g. in the form of a partial perforation, which does not fully penetrate the thickness of the foil hose 5.

A label 19 is attached to the second section 14.

FIG. 4 shows a device, in which the spring element 10 extends from the opening 6, on which the foil hose 5 is connected by means of the first attachment 8 with the hand covering 1, over the area of the hand covering 1 up to the second attachment 9. The spring element 10 can be formed in one piece with a second spring element 12, which is arranged at the second attachment 9. Here, a spiral-shaped spring element 10 is shown, which can be annular in shape in the area of the opening 6. Alternatively, the spring element 10 can have ridges, which extend longitudinally with respect to the foil hose 5. The second spring element 12 can likewise be annular in shape.

In the embodiment of FIG. 4, the second section 14 is double-walled fitted with a socket 20, which is provided for filling in a temperature control medium, e.g. water, and is closable by a valve. The valve can e.g. be a foil valve, which closes irreversibly after filling of the double shell. As is generally preferred, this embodiment has a screening device 23 and between the latter and the second section 14 a predetermined tearing point 18.

FIG. 5 in a section shows a possible formation of a spring element 10, 12 on the foil hose 5 by an elastic element 11 which is arranged on the external side of the foil hose and a section 21 of the foil hose 5 is laid back resp. folded over the elastic element 11. Here, the laid-back section 21 of the foil hose 5 can be connected for attachment 24 to a section of the foil hose 5, which is adjacent to the elastic element 11, and/or connected to the elastic element 11, e.g. by gluing or welding, preferably by means of a weld seam 16 running completely or sectionwise circumferentially about the spring element 10, 12.

The spring element 10, which spans open the opening 6 of the foil hose 5, and/or the second spring element 12 in this manner can be formed as a laid-back and fixed section 21 of the foil hose 5, optionally with an elastic element 11. It is generally preferred that the first and second attachment 8, 9 connects the spring element 10 resp. the second spring element 12 to the foil hose 5.

FIG. 6 shows a section of the second section 14 of the device, which can be partially double-walled, with a closed grommet 22. The grommet 22 can be cut open for outflow of ejaculate from the second section 14, as is indicated by the dashed line.

### Example

### Low-Germ Semen Collection from the Boar

For the method for semen collection of young boars of the breed Pietrain, a device according to FIG. 3 was used. The boar were allowed to mount onto a phantom. A technician had pushed his hand into the glove-shaped hand covering 1 and grasped around the foil hose 5 by means of the finger guide 17 and the thumb guide 15 in the area, which was attached along the hand covering 1. The opening 6, which spanned open by the spring element 10 was guided over the penis tip of the boar and light pressure was exerted through the foil hose 5 onto the penis tip. The ejaculate flew through the foil hose 5 spanned open by the second spring element 12 in its second section 14. Therein, the other hand was free, so that the technician, who was sitting next to the boar, could support himself, or the other hand could be used to hold the second section 14. Subsequently, the foil hose 5 was removed from the penis. The bulbourethral gland secretion was retained by the screening device 23 and the second section 14 could be separated from the bulbourethral gland secretion by tearing-off along the predetermined tearing point 18. The ejaculate contained in the second section 14 was analyzed and used for insemination after dilution.

It has shown that the device allows simple handling, which essentially corresponds to the conventional hand method and that a time-consuming connection of the penis to an automatic sperm collection device is avoided. The tests showed that average volumes of ejaculate of approx. 250-260 ml were obtained, the total number of sperm (measured by means of NucleoCounter SP-100 after permeabilization and staining with propidiumiodide at 488 nm) per ejaculate of approx. 98.8 billion corresponded to those which were achieved with the conventional hand method and were therefore significantly higher than those, which were achieved in a comparative test using automatic sperm collection devices (80 -87 billion).

The total bacterial count (CFU) of the ejaculates was determined after incubation in liquid culture (Uricult, Orion Diagnostica, Finland) for 48h at 37° C. While for the conventional hand method, which was carried out for comparison, a total mean value of 2.9×10⁶ CFU/ml was found, the method using the device according to the invention yielded a total mean value of approx. 7×10⁵ CFU/ml.

### LIST OF REFERENCE NUMERALS

1 hand covering

2 finger section

3 thumb section

4 hand opening

5 foil hose

6 opening

7 first end

8 first attachment

9 second attachment

10 spring element

11 elastic element

12 second spring element

13 second end

14 second section

15 thumb guide

16 weld seam

17 finger guide

18 predetermined tearing point

19 label

20 socket

21 laid-back section of foil covering 5

22 grommet

23 screening device

24 attachment

1. Device for collecting ejaculate from the boar, having a hand covering (1) with a finger section (2) and a thumb section (3) for accommodating a hand, a foil hose (5) attached to one side of the hand covering (1) between the finger section (2) and the thumb section (3), the first end (7) of which foil hose (5) having an opening (6), which is spanned open by a spring element (10) and the second end (13) of which opposite the first end (7) is closed, wherein the foil hose (5) at its first end (7) is connected to the hand covering (1).

2. Device according to claim 1, characterized in that the first end (7) of the foil hose (5) is connected with the edge of the hand covering (1), which extends between the finger section (2) and the thumb section (3).

3. Device according to claim 1, characterized in that the finger section (2) has finger guides (17) and the thumb section (3) has a thumb guide (15).

4. Device according to claim 1, characterized in that the foil hose (5) has, at a spacing from the opening (6), a second spring element (12) and is connected in this area to the hand covering (1).

5. Device according to claim 1, characterized in that the spring element (10), which spans open the opening (6) of the first end (7), and/or the second spring element (12) is formed by a laid-back and fixed section (21) of the foil hose (5) and/or by an elastic element (11).

6. Device according to claim 1, characterized in that the spring element (10), which spans open the opening (6) of the first end (7), and/or the second spring element (12), is directly connected to the hand covering (1).

7. Device according to claim 1, characterized in that the spring element (10), which spans open the opening (6) of the first end (7), from the opening (6) extends longitudinally along the foil hose (5) at least to 30% of the section, along which the foil hose (5) lies against the hand covering (1).

8. Device according to claim 1, characterized in that the foil hose (5) between its first end (7) and second end (13) has a screening device (23), which spans over the cross-section of the foil hose (5).

9. Device according to claim 1, characterized in that the foil hose (5) between its first end (7) and second end (13) has a predetermined tearing point (18).

10. Device according to claim 1, characterized in that the foil hose (5) is double-walled in its second section (14) adjacent to the second end (13) and has a socket (20) for filling a temperature control medium into the double shell.

11. Method for collecting ejaculate from the boar, characterized by the insertion of a hand into the hand covering (1) of a device according to claim 1 and arranging the opening (6) at the first end (7) of the foil hose (5) over the tip of the penis of the boar.

12. Method according to claim 11, characterized by the insertion of fingers into the finger section (2) and insertion of a thumb into the thumb section (3), wherein the opening (6) at the first end (7) of the foil hose (5) is spanned open by the spring element (10).

13. Method according to claim 11, characterized in that the foil hose (5) is double-walled in its second section (14) adjacent to the second end (13) and a temperature control medium is filled through a socket (20) into the double shell.
